(19) United States
(12) Patent Application Publication
(10) Pub. No.: US 2017/0177124 A1
(43) Pub. Date: Jun. 22, 2017

(54) DISPLAY APPARATUS WITH TOUCH DETECTION FUNCTION

(71) Applicant: Innolux Corporation, Chu-Nan (TW)

(72) Inventor: Shinji KONOSHITA, Chu-Nan (TW)

(73) Assignee: Innolux Corporation, Chu-Nan (TW)

(21) Appl. No.: 14/973,400

(22) Filed: Dec. 17, 2015

(51) Int. Cl. G06F 3/047; G06F 3/041

(52) U.S. Cl. CPC G06F 3/047; G06F 3/0412; G06F 2203/04112

(57) ABSTRACT

A display apparatus includes a display medium and a plurality of touch sensing electrodes. The display medium includes a plurality of pixels each constituted by a plurality of color regions with different colors arranged in a matrix. Each of the touch sensing electrodes includes a plurality of conductive wires overlapping with the pixels and including a first portion extending in a first direction at a first angle with respect to the column direction and a second portion connecting with the first portion extending in a second direction at a second angle with respect to the column direction. The pixels and the touch sensing electrodes have specific size parameters, the moiré pattern occurring on the display apparatus can be reduced.

### BACKGROUND OF THE INVENTION

Field of the Invention

The invention relates in general to a display apparatus, and more particularly to a display apparatus with touch detection function.

Description of the Related Art

In recent years, the development of a display apparatus equipped with a touch sensor is a huge breakthrough in the history of technology. Typically, the display apparatus having a touch sensor equips a plurality of translucent conductive material such as indium tin oxide (ITO) as touch sensing electrodes mounted on or integrated within a display device, such as a liquid crystal display device, so as to provide the display device a touch detection function and allow information input by using the touch sensor as a substitute for a typical input device, such as a keyboard, a mouse, and a keypad.

Currently, the display apparatus with the touch sensor is further required to have lower-resistance to achieve a smaller thickness, a larger screen size, or a higher definition. To reduce the sensor resistance, alternative conductive material, such as a metallic material other than ITO is effectively used for reducing the resistance of the touch sensing electrodes.

However, using the metallic material to serve as the touch sensing electrodes can cause moiré pattern to be seen due to the interference between pixels of the display device and the metallic material. How to minimize the effect of moiré and to keep the higher resolution of the display apparatus without affecting its display quality has become a prominent task for people in the technology field.

Therefore, it has become a prominent task for the industries to provide an advanced display apparatus with touch detection function to obviate the drawbacks encountered in the prior art.

### SUMMARY OF THE INVENTION

One embodiment of the description is directed to a display apparatus with a touch detection function. The display apparatus comprises a display medium and a plurality of touch sensing electrodes. The display medium includes a plurality of pixels each constituted by a plurality of color regions with different colors arranged in a matrix with a plurality of and rows and columns, wherein the pixel has a first side (Px) along a row direction and a second side (Py) along a column direction. The touch sensing electrode includes a plurality of conductive wires. The conductive wire overlaps with the pixels and includes at least one first portion extending in a first direction at a first angle with respect to the column direction, and at least one second portion connecting with the first portion and extending in a second direction at a second angle with respect to the column direction. The first portion crosses at least one pixel serving as a hypotenuse of a right triangle with a first leg (Tx) parallel to the row direction and a second leg (Ty) parallel to the column direction. A ratio of lengths of the first leg (Tx) and the first side (Px) substantially ranges from 1/3 to 7/3; and a ratio of lengths of the second leg (Ty) and the second side (Py) is substantially larger than 0.8 and less than 2.

In according to some embodiments of the present invention, when the display apparatus is viewed by an user from a first viewing angle, the conductive wires in a predetermined set of adjacent pixels has a vertical shadow casted on the pixels to define a first shielding area on at least two of the first color regions. When display apparatus is viewed by the user from a second viewing angle different from the first viewing angle, the conductive wires in the predetermined set of adjacent pixels has a vertical shadow casted on the pixels to define a second shielding area on the at least two of the first color regions. The first shielding area is substantially equal to the second shielding area.

In according to some embodiments of the present invention, the predetermined set of adjacent pixels can include at least two adjacent pixels arranged along the row direction, can include at least two adjacent pixels arranged along the column direction, or can include a plurality of adjacent pixels arranged in a matrix.

In accordance with the embodiments of the present description, by applying the conductive wires with specific size parameters, the moiré pattern occurring on the display apparatus can be eliminated or reduced. In addition the specific size parameters can also compensate the color phase occurring between two adjacent pixels due to the light shielding of the conductive wires and the change of view angle.

### BRIEF DESCRIPTION OF THE DRAWINGS

The above and other aspects of the invention will become better understood with regard to the following detailed description of the preferred but non-limiting embodiment(s). The following description is made with reference to the accompanying drawings.

FIG. 1A is a cross-sectional view illustrating a display apparatus with a touch detection function in accordance with one embodiment of the present invention;

FIG. 1B is a plane view profile of the display apparatus as depicted in FIG. 1A;

FIGS. 2A to 2H illustrate the arrangements of various sets of the touch detection electrodes and the pixels with different size parameters and the simulation images of the display apparatus applying the same;

FIGS. 3A and 3B are simplified cross sectional views of a display apparatus in accordance with one embodiment of the present invention, illustrating the shadow coverage of the touch detection electrodes casted on the pixels of the display apparatus observed at different viewing angles.

FIGS. 4A and 4B are top views of a display apparatus in accordance with one embodiment of the present invention, illustrating the shadows coverage of the touch detection electrodes casted on two adjacent pixels of the display apparatus respectively at a vertical view angle and at an oblique view angle;

FIGS. 5A and 5B are top views of a display apparatus in accordance with another embodiment of the present invention, respectively illustrating the shadow coverage of the touch detection electrodes casted on two adjacent pixels of the display apparatus observed at a vertical viewing angle and at an oblique view angle;

FIGS. 6A and 6B are top views of a display apparatus in accordance with yet another embodiment of the present invention, respectively illustrating the shadow coverage of the touch detection electrodes casted on four adjacent pixels observed at a vertical viewing angle and at an oblique view angle; and

FIGS. 7A and 7B are top views of a display apparatus in accordance with yet another embodiment of the present invention, respectively illustrating the shadow coverage of the touch detection electrodes casted on eight pixels of the display apparatus observed at a vertical viewing angle and at an oblique viewing angle.

### DETAILED DESCRIPTION OF THE INVENTION

The disclosure provides an improved display apparatus with a touch detection function to minimize the effect of moiré due to the light shielding of the touch sensing electrodes. To make the objects, technical features and advantages of the invention more apparent and easily understood, a number of exemplary embodiments are exemplified below with accompanying drawings.

It should be noted that the implementations and methods disclosed in the present invention are not for limiting the invention. The invention still can be implemented by using other features, elements methods and parameters. Exemplary embodiments are provided for illustrating the technical features of the invention, not for limiting the scope of protection of the invention. Any persons ordinarily skilled in the art can make suitable modifications and adjustments based on the description of the specification without breaching the spirit of the invention. Common reference designations are used throughout the drawings and embodiments to indicate the same elements.

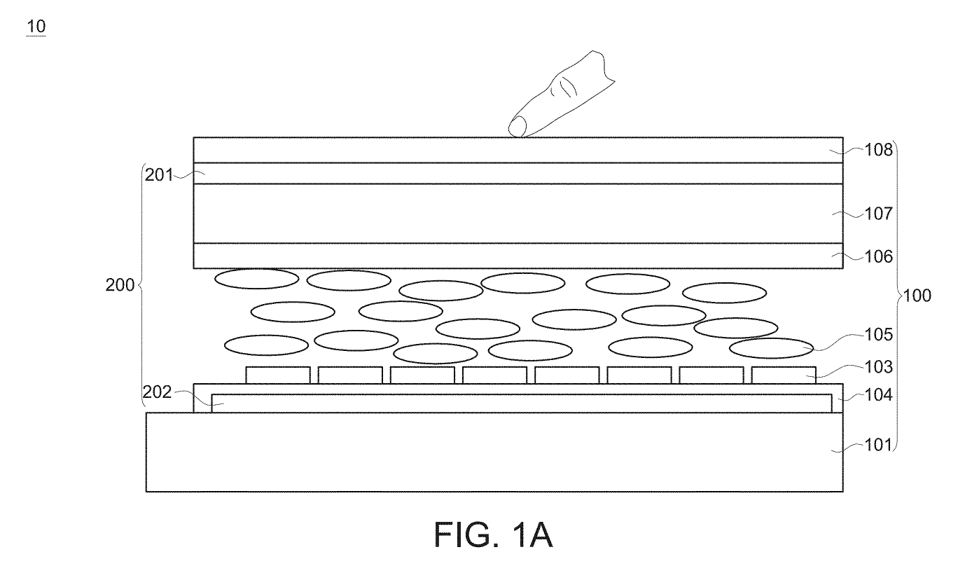

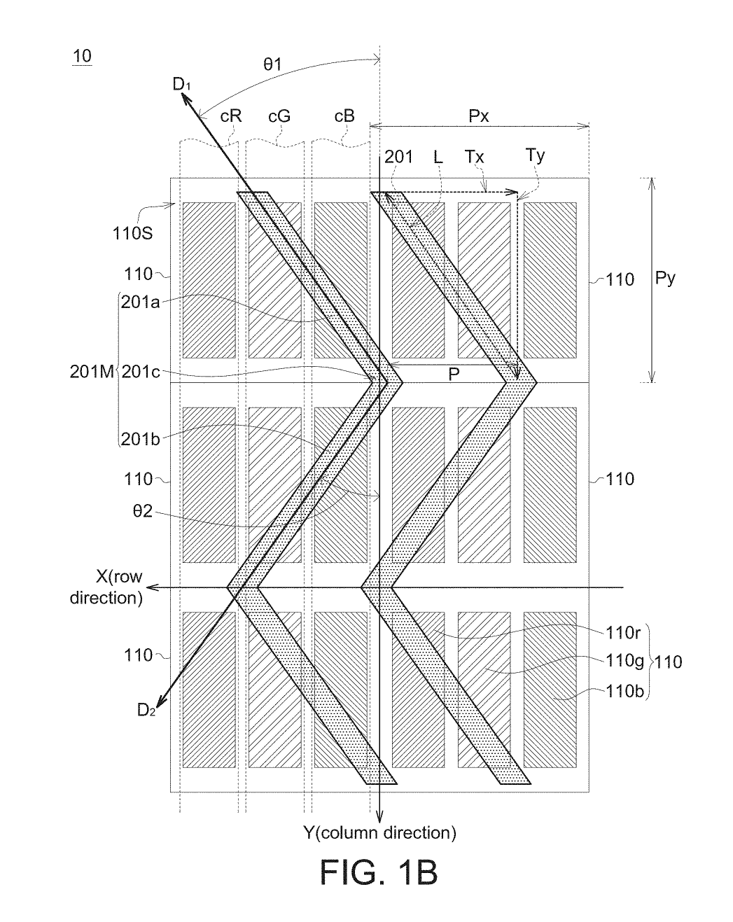

FIG. 1A is a cross-sectional view illustrating a display apparatus 10 with a touch detection function in accordance with one embodiment of the present invention. The display apparatus 10 includes a display medium 100 and a touch sensing structure 200. In some embodiments of the present invention, the touch sensing structure 200 is directly bound on the light existing surface of the display medium 100. In some other embodiments of the present invention, the touch sensing structure 200 is integrated with the display medium 100.

For example, in the present embodiment, the display medium 100 is a liquid crystal display (LCD) panel, and the display medium 100 include a first substrate 101, a pixel electrode layer 103 formed on the first substrate 101, a liquid crystal layer 105 disposed on the pixel electrode layer 103, a color filter 106 disposed on the liquid crystal layer 105, a second substrate 107 disposed on the color filter 106 and a polarizing plate 108 disposed on the second substrate 107. The first substrate 101 can be an array substrate, and the second substrate 107 can be a color filter substrate.

The touch sensing structure 200 includes a plurality of touch sensor electrodes. The touch sensor electrodes can be touch detection electrodes or drive electrodes. For example, in this embodiment, the touch sensing structure 200 includes a plurality of touch detection electrodes 201 and a plurality of drive electrode 202. In FIG. 1, the touch detection electrodes 201 and the drive electrodes 202 only shows a layer for simplicity. The touch detection electrodes 201 and the drive electrodes 202 can be patterned according to needs.

The touch detection electrodes 201 can be formed on the second substrate 107 and between the second substrate 107 and the polarizing plate 108. The color filter layer 106 can be formed on the second substrate 107. The touch detection electrodes 201 and the color filter layer 106 can be formed on different sides or the same side of the second substrate 107. The drive electrode 202 can be formed on the first substrate and between the first substrate 101 and the pixel electrode layer 103 and insulated from the pixel electrode layer 103 by an insulation layer 104.

The drive electrodes 202 and the touch detection electrodes 201 are three-dimensionally intersect with each other. For example, in the preset invention, the touch detection electrodes 201 and the drive electrodes 202 are disposed on different planes; the touch detection electrodes 201 may extend along one direction; and the drive electrodes 202 may extend along another direction. However, the structure of the touch panel 200 is not limited to this regard. In some embodiments, the touch detection electrodes 201 and the drive electrodes 202 can be formed at the same plane.

FIG. 1A shows a hybrid type touch display device. That is, the touch detection electrodes 201 are formed on the second substrate 107 and the drive electrodes 202 are formed on the first substrate 101. Alternatively, in some embodiments of the present invention, both the touch detection electrodes 201 and the drive electrodes 202 can be formed on the second substrate 107, thus constituting an on-cell touch display device. Alternatively, in some embodiments of the present invention, both the touch detection electrodes 201 and the drive electrodes 202 can be formed on another substrate (not shown) disposed on the second substrate 107 towards the touch side, thus constituting an out-cell touch display device. In some embodiments of the present invention, touch detection electrodes 201 and the drive electrodes 202 can be formed on the same substrate, or can be formed on different substrates. The position of the detection electrodes 201 and the drive electrodes 202 can be exchanged according to needs.

In some embodiments of the present invention, the touch detection electrodes 201 and the drive electrodes 202 may be made of conductive material, such as ITO or metal. In the present embodiment, the touch detection electrodes 201 and the drive electrodes 202 may be constituted by a plurality of conductive wires respectively formed on two different planes, extending along two different directions, and integrated within the display medium 100.

In the state in which the finger is in contact with (or in proximity of) the touch detection electrode 201, electrostatic capacitance generated by the finger may interrupt the capacitance value between the touch detection electrodes 201 and the drive electrode 202, and then the capacitive difference can be obtained, so as to provide the display apparatus 10 a touch detection function.

FIG. 1B is a plane view of the plane profile of the display apparatus 10 as depicted in FIG. 1A. In some embodiments of the present invention, the display medium 100 may include a plurality of pixels 110. Each pixel 110 includes a plurality of color regions and a shielding region. For example, in the present embodiment, each of the pixels 110 shapes as a rectangle having three color regions 110r, 110g and 110b with three different colors, such as red (R), green (G), and blue (B). The color regions 110r, 110g and 110b of the pixel 110 are arranged periodically in a predetermined order. In each pixel 110, the shielding region 110S is disposed between the color regions and surrounds the color regions. The shielding region 110S can be the black matrix. For example, the color regions are arranged in a matrix with a plurality of rows and columns. The pixel 110 has a first side (Px) along a row direction (X) and a second side (Py) along a column direction (Y). The first side is the pixel pitch along the row direction, and the second side is the pixel pitch along the column direction. In some embodiments, color regions in the same column have the same color. For example, color regions in column cR have red color, color regions in column cG have green color, color regions in column cB have blue color.

According to some embodiments of the present invention, the touch detection electrode 201 and/or the drive electrode 202 can be in the form of conductive wires. The design on shape and size of the touch detection electrode 201 will be described in the following as an example. Similar design can be made on the drive electrode 202, and description on the drive electrode 202 will be omitted for simplicity.

In some embodiments, the touch detection electrode 201 include a plurality of conductive wires 201M overlapping with the pixels 110. Each of the conductive wire 201M of the touch detection electrodes 201 includes at least one first portion 201a and a second portion 201b. In some embodiments, the conductive wire 201M can be a metal wire. For example, the metal wire can be made of Cu, Al or Ag. The first portion 201a extends in a first direction (D1) at a first angle θ1 with respect to the column direction (Y). The second portion 201b is connected to the first portion 201a at a bent portion 201c and extends in a second direction (D2) at a second angle θ2 with respect to the column direction (Y).

In detailed, each of the conductive wires 201M of the touch detection electrodes 201 is formed as a zigzag line or a wavy line. The conductive wire 201M includes a plurality of the first portions 201a and a plurality of the second portions 201b, wherein the first portions and the second portions are continuously connected along the column direction (Y) and bent at a plurality of bent portions 201c. Two adjacent wires disposed along the row direction (X) are separated from each other with a pitch P.

The length of the first portions 201a can be the same as or different from that of the second portions 201b. The first angle θ1 can be the same as or different from the second angle θ2. However, in the present embodiment, the first portions 201a and the second portions 201b have the same length. The first angle θ1 is substantially equal to the second angle θ2. The first portion 201a has a span L crossing one of the pixels 110 serving as a hypotenuse of a right triangle T with a first leg Tx parallel to the row direction (X) and a second leg Ty parallel to the column direction (Y).

The touch detection electrodes 201 and the pixels 110 with specific size parameters can be integrated to reduce the effect of moiré pattern in the display apparatus 10 when image is displayed. For the convenience of description, only the size parameter of the first portion 201a is described thereafter. However, it should be appreciated that the size parameter of other segments of the touch detection electrodes 201 or the drive electrode 202 can also available for implementing the objects and advantage of the present invention.

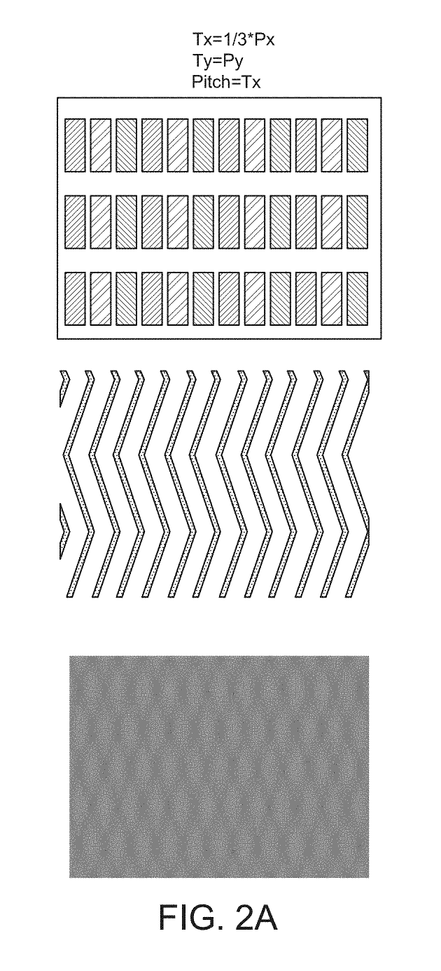

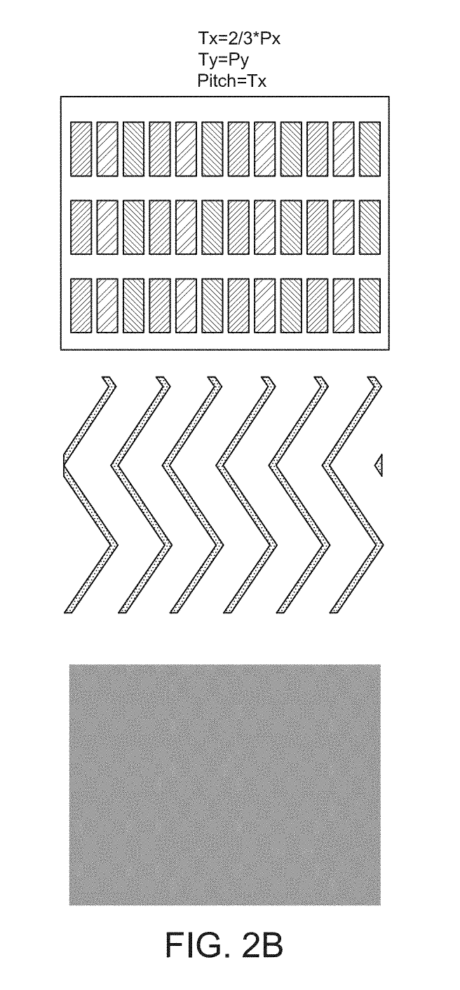

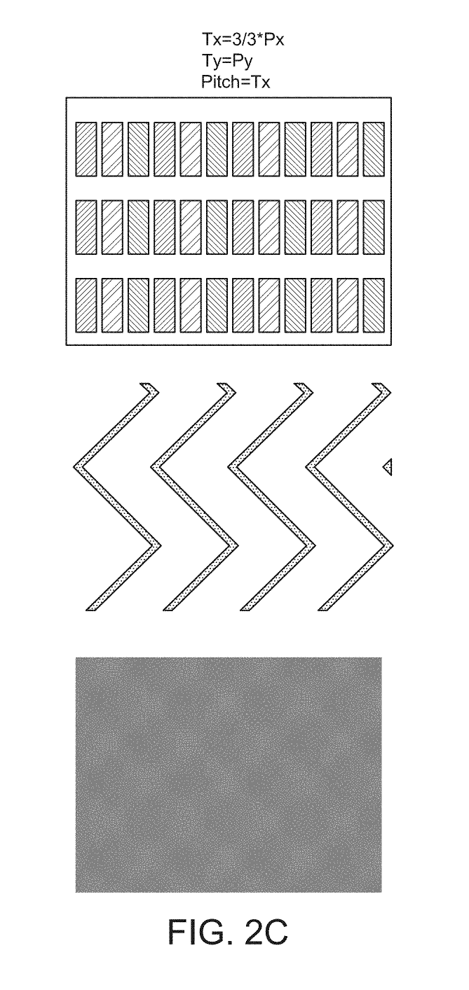

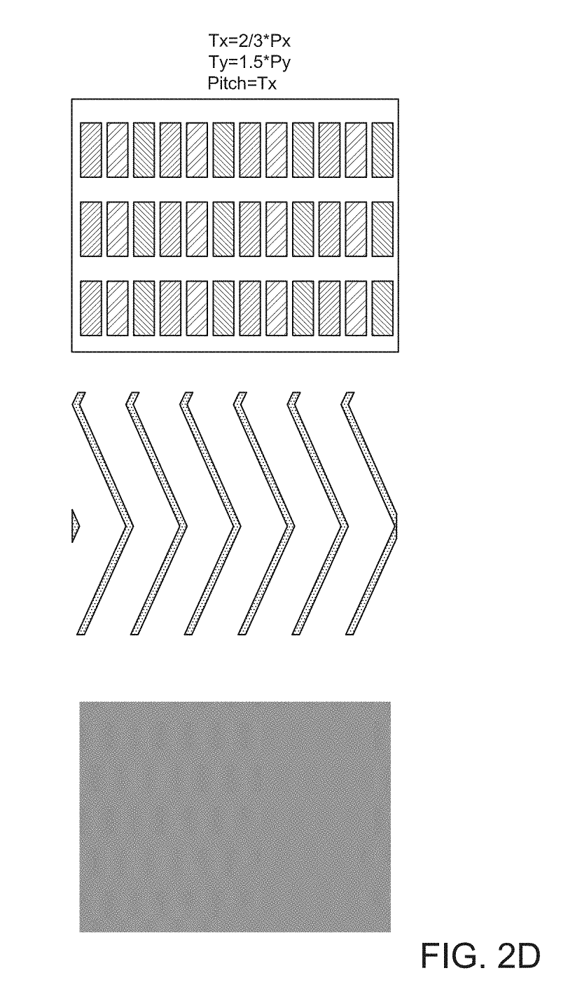

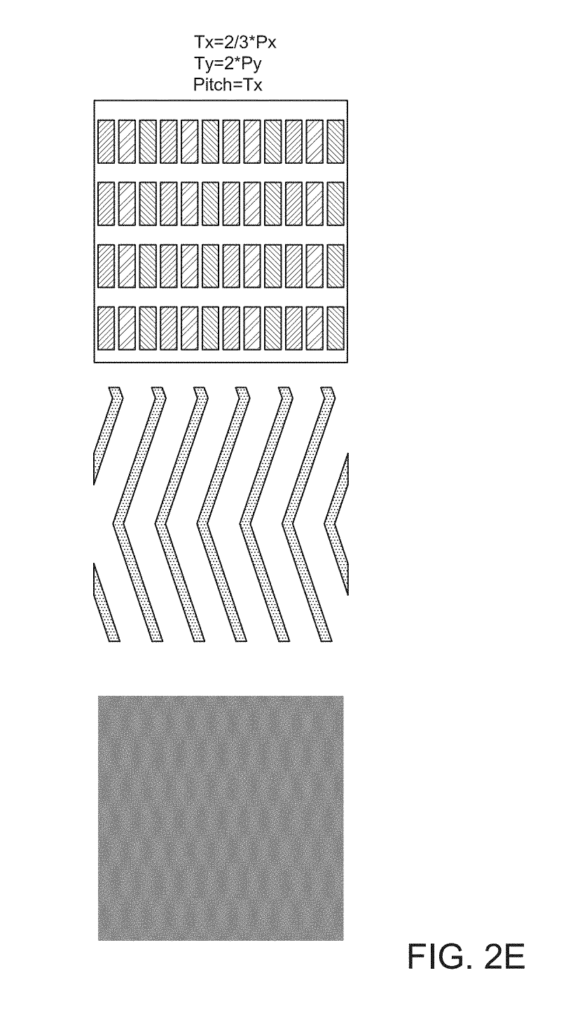

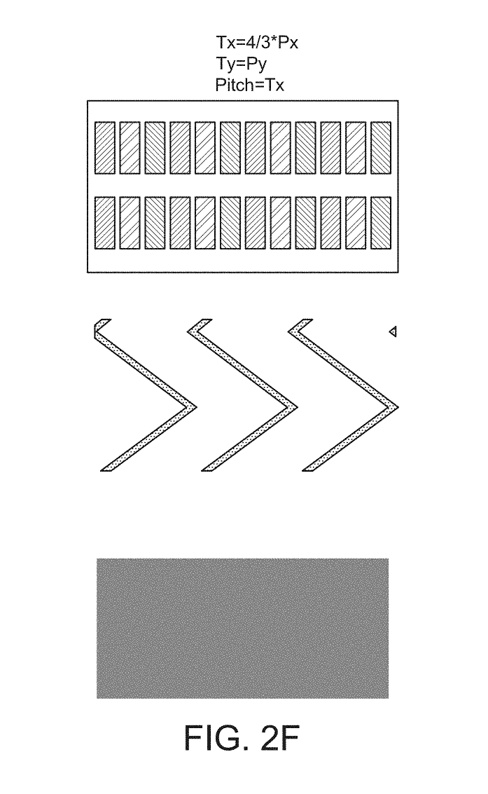

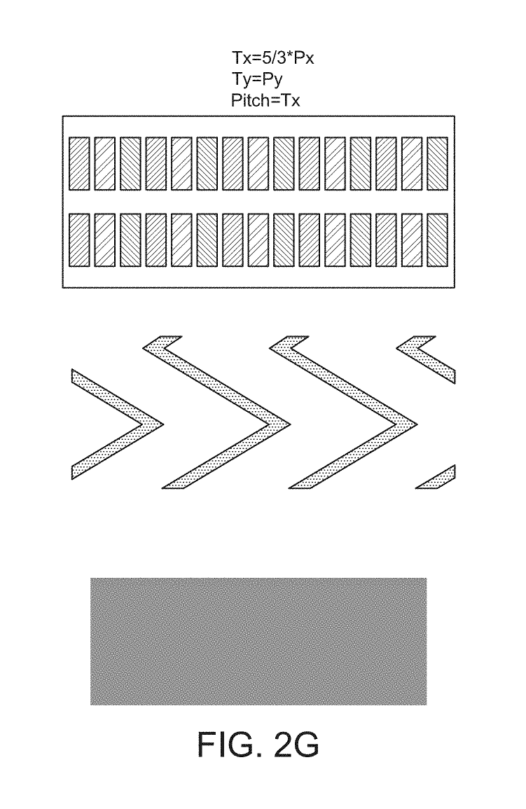

For example, FIGS. 2A to 2H illustrate the arrangements of various sets of the touch detection electrodes 201 and the pixels 110 with different size parameters and the simulation images of the display apparatus 10 applying the same.

In FIG. 2A, the ratio of lengths of the first leg Tx and the first side Px of the corresponding pixel 110 is substantially less than and equal to 1/3 (Tx≦1/3×Px); the ratio of lengths of the second leg Ty and the second side Py is substantially equal to 1 (Ty=Py); and the ratio of the pitch P to the length of the first leg Tx is substantially equal to 1 (P=Tx). The simulation image of the display apparatus 10 reveals strong moiré effect.

In FIG. 2B, the ratio of lengths of the first leg Tx and the first side Px of the corresponding pixel 110 is substantially less than and equal to 2/3 (Tx≦2/3*Px); the ratio of lengths of the second leg Ty and the second side Py of the corresponding pixel 110 is substantially equal to 1 (Ty=Py); and the ratio of the pitch P to the length of the first leg Tx is substantially equal to 1 (P=Tx). The simulation image of the display apparatus 10 reveals less moiré pattern.

In FIG. 2C, the ratio of lengths of the first leg Tx and the first side Px of the corresponding pixel 110 is substantially equal to 3/3 (Tx=3/3*Px); the ratio of lengths of the second leg Ty and the second side Py of the corresponding pixel 110 is substantially equal to 1 (Ty=Py); and the ratio of the pitch P to the length of the first leg Tx is substantially equal to 1 (P=Tx). The simulation image of the display apparatus 10 reveals medium moiré effect.

From the above results, it can be indicated that when the ratio of lengths of the second leg Ty and the second side Py (Ty/Py) and the ratio of the pitch P to the length of the first leg Tx (P/Tx) are fixed, the moiré effect of the display apparatus 10 can be reduced significantly by applying the set of the touch detection electrodes 201 and the pixels 110 having the ratio of lengths of the first leg Tx and the first side Px substantially greater than or equal to 1/3 (Tx≧1/3×Px) in the display apparatus 10.

In some other embodiments of the present invention, the ratio of lengths of the second leg Ty and the second side Py can be further taken account for reducing moiré effect in the display apparatus 10.

In FIG. 2D, the ratio of lengths of the first leg Tx and the first side Px of the corresponding pixel 110 is substantially equal to 2/3 (Tx=2/3*Px); the ratio of lengths of the second leg Ty and the second side Py of the corresponding pixel 110 is substantially equal to 1.5 (Ty=1.5*Py); and the ratio of the pitch P to the length of the first leg Tx is substantially equal to 1 (P=Tx). The simulation image of the display apparatus 10 reveals medium moiré effect.

In FIG. 2E, the ratio of lengths of the first leg Tx and the first side Px of the corresponding pixel 110 is substantially equal to 2/3 (Tx=2/3*Px); the ratio of lengths of the second leg Ty and the second side Py of the corresponding pixel 110 is substantially equal to 2 (Ty=2*Py); and the ratio of the pitch P to the length of the first leg Tx is substantially equal to 1 (P=Tx). The simulation image of the display apparatus 10 reveals strong moiré effect.

From the above results (FIG. 2B, 2D, 2E), it can be indicated that when the ratio of lengths of the first leg Tx and the first side Px (Tx/Px) and the ratio of the pitch P to the length of the first leg Tx (P/Tx) are fixed, the moiré effect of the display apparatus 10 can be reduced significantly by applying the set of the touch detection electrodes 201 and the pixels 110 having the ratio of lengths of the second leg Ty and the second side Py substantially less than 2 (Ty<2*Py) in the display apparatus 10.

In yet other embodiments of the present invention, the ratio of the pitch P to the length of the first leg Tx (P/Tx) can be further taken account for reducing moiré effect in the display apparatus 10.

In FIG. 2F, the ratio of lengths of the first leg Tx and the pixel width Px of the corresponding pixel 110 is substantially equal to 4/3 (Tx=4/3*Px); the ratio of lengths of the second leg Ty and the second side Py of the corresponding pixel 110 is substantially equal to 1 (Ty=Py); and the ration of the pitch P to the length of the first leg Tx is substantially equal to 1 (P=Tx). The simulation image of the display apparatus 10 reveals less moiré pattern.

In FIG. 2G, the ratio of lengths of the first leg Tx and the pixel width Px of the corresponding pixel 110 is substantially equal to 5/3 (Tx=5/3*Px); the ratio of lengths of the second leg Ty and the second side Py of the corresponding pixel 110 is substantially equal to 1 (Ty=Py); and the ratio of the pitch P to the length of the first leg Tx is substantially equal to 1 (P=Tx). The simulation image of the display apparatus 10 reveals less moiré pattern.

In FIG. 2H, the ratio of lengths of the first leg Tx and the first side Px of the corresponding pixel 110 is substantially equal to 2/3 (Tx=2/3*Px); the ratio of lengths of the second leg Ty and the second side Py of the corresponding pixel 110 is substantially equal to 1 (Ty=Py); and the ratio of the pitch P to the length of the first leg Tx is substantially equal to 1/2 (P=1/2*Tx). The simulation image of the display apparatus 10 reveals strong moiré effect.

From the above results, it can be indicated that when the ratio of lengths of the second leg Ty and the second side Py (Ty/Py) and the ratio of the pitch P to the length of the first leg Tx (P/Tx) are fixed, the moiré effect can be reduced when the display apparatus 10 applies the set of the touch detection electrodes 201 and the pixels 110 having the ratio of lengths of the first leg Tx and the first side Px substantially greater than 5/3 (Tx>5/3*Px, e.g Tx=7/3*Px). And when the ratio of the pitch P to the length of the first leg Tx (P/Tx) is greater than 1/2 (P≧1/2*Tx), the moiré effect occurring in the display apparatus 10 can be reduced.

In sum, the moiré effect occurring in the display apparatus 10 can be reduced when the ratio of lengths of the first leg Tx and the first side Px of the corresponding pixel 110 (Tx/Px) substantially ranges from 1/3 to 7/3; the ratio of lengths of the second leg Ty and the second side Py of the corresponding pixel 110 (Ty/Py) is substantially larger than 0.8 and less than 2; and the ratio of the pitch P to the length of the first leg Tx (P/Tx) is equal to or less than 1.2, for example, equal to or less than 1, and for example, ranges from 1/2 to 1. In some embodiments, the ratio of lengths of the first leg (Tx) and the first side (Px) can be larger than 1/3 and less than 7/3, range from 0.35 to 2, range from 2/3 to 2, or range from 2/3 to 5/3. In some embodiments, the ratio of lengths of the second leg Ty and the second side Py can range from 0.8 to 1.7, or range from 1 to 1.5. In some embodiments, the ratio of the pitch P to the length of the first leg Tx can be larger than 1/2 and less than 1.2, range from 0.6 to 1.2, or range from 0.7 to 1.1.

In some embodiments of the present invention, applying the touch detection electrodes 201 and the pixels 110 with specific size parameters can compensate color phase caused by the light shielding of the touch detection electrodes 201 especially when the viewing angle of the user is changed.

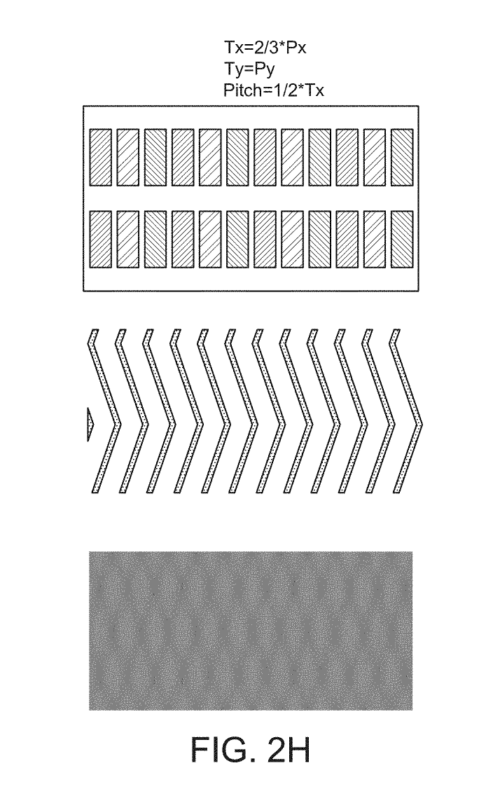

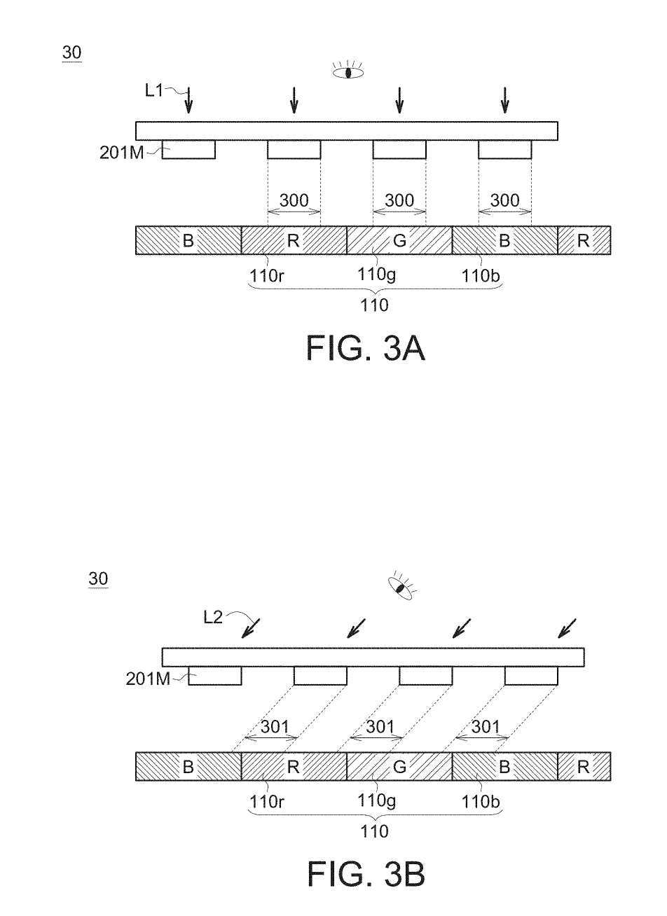

FIGS. 3A and 3B are simplified cross sectional views of the display apparatus 30 in accordance with one embodiment of the present invention, illustrating shadow coverage of the conductive wires 201M casted on the pixels 110 of the display apparatus 30 observed at different viewing angles. When a user views the display apparatus 10 with a first viewing angle, for example, right viewing angle (or vertical viewing angle), light L1 vertically comes out of the display apparatus 10 and a vertical shadow 300 of the conductive wires 201M can be casted on the pixels (see FIG. 3A). When the user views the display apparatus 10 with a second viewing angle, for example, an oblique viewing angle, light L2 obliquely comes out of the display apparatus 10, an oblique shadow 301 of the conductive wires 201M can be casted on the pixels and the shadow coverage may shift to the left (see FIG. 3B). If the shadow coverage (area) of the oblique shadow 301 is different from the coverage of the vertical shadow 300 casted on the color regions (such as 110r, 110g or 110b) with the same color, color phase may occur.

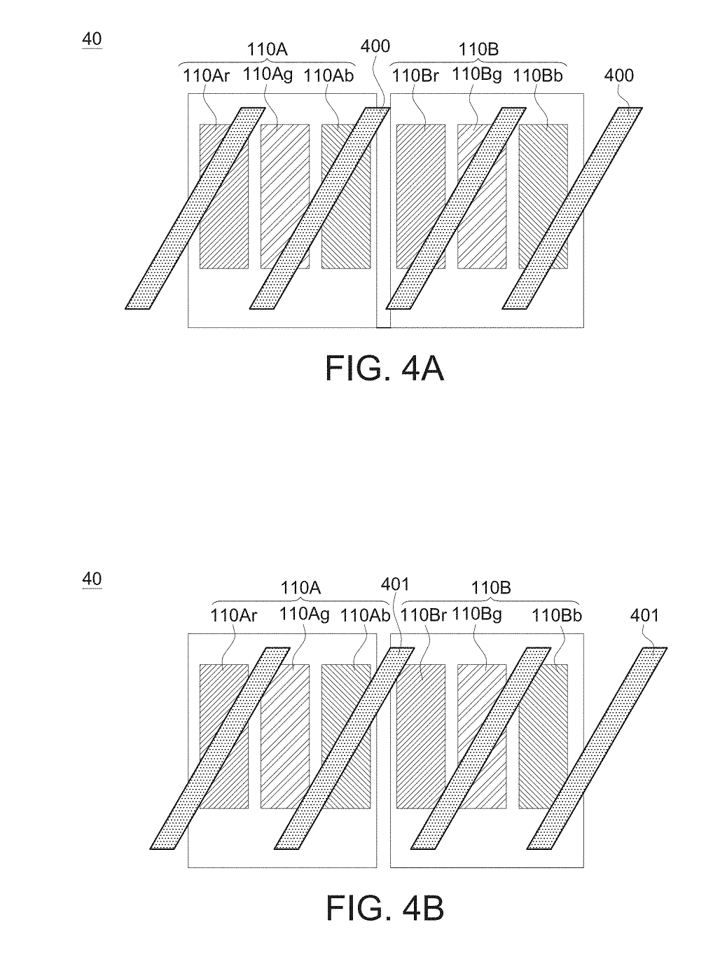

FIGS. 4A and 4B are top views of a display apparatus 40 in accordance with one embodiment of the present invention, respectively illustrating the shadow coverage of the conductive wires 201M casted on two adjacent pixels 110A and 110B of the display apparatus 40 at a vertical view point (FIG. 4A) and at an oblique view point (FIG. 4B). The two adjacent pixels 110A and 110B are arranged along the row direction.

In the present embodiment, the display apparatus 40 applies the set of the conductive wires 201M and the pixels 110 depicted in FIG. 2B which has the ratio of lengths of the first leg Tx and the first side Px of the corresponding pixel 110 (Tx/Px) substantially equal to 2/3; the ratio of lengths of the second leg Ty and the second side Py of the corresponding sub-pixel 110 (Ty/Py) substantially equal to 1; and the ratio of the pitch P to the length of the first leg Tx (P/Tx) substantially equal to 1.

FIG. 4A illustrates the vertical shadow 400 of the conductive wires 201M casted on the pixels 110A and 110B observed at the vertical view angle. FIG. 4B illustrates the oblique shadow 401 of the conductive wires 201M casted on the pixels 110A and 110B observed at the oblique view angle. For the convenience of description, merely two adjacent pixels 110A and 110B arranged along the row direction (X) are shown. However, it should be appreciated that there are still other pixels included in the display apparatus 40.

The portion of the vertical shadow 400 casted on the color region 110Ar with red color in the pixel 110A has an area substantially equal to the portion of the vertical shadow 400 casted on the color region 110Br with red color in the pixel 110B; the portion of the vertical shadow 400 casted on the color region 110Ag with green color in the pixel 110A has an area substantially equal to the portion of the vertical shadow 400 casted on the color region 110Bg with green color in the pixel 110B; and the portion of the vertical shadow 400 casted on the color region 110Ab with blue color in the pixel 110A has an area substantially equal to the portion of the vertical shadow 400 casted on the color region 110Bb with blue green color in the pixel 110B. In other words, the total area of the portion of the vertical shadow 400 casted on the pixel 110A is the same to the total area of the portion of the vertical shadow 400 casted on the pixel 110B.

When the view angle is changed, the shadow coverage may shift to the right (see FIG. 4B), such that the portion of the oblique shadow 401 casted on the color region 110Ar with red color in the pixel 110A has an area substantially larger than the portion of the oblique shadow 401 casted on the color region 110Br with red color in the pixel 110B; the portion of the oblique shadow 401 casted on the color region 110Ag with green color in the pixel 110A has an area substantially smaller than the portion of the oblique shadow 401 casted on the color region 110Bg with green color in the pixel 110B; and the portion of the oblique shadow 401 casted on the color region 110Ab with blue color in the pixel 110A has an area substantially larger than the portion of the oblique shadow 401 casted on the color region 110Bb with blue green color in the pixel 110B. The total area of the portion of the oblique shadow 401 casted on the pixel 110A is thus different from the total area of the portion of the oblique shadow 401 casted on the pixel 110B, and color phase may occur when the view angle is changed.

Although, the shadow coverage (shielding area) of the oblique shadow 401 casted on the color region with a certain color in a particular pixel (either the pixels 110A or 110B) is different from the shadow coverage of the vertical shadow 400 casted on the same color region. It still can be observed that the total shadow coverage of the oblique shadow 401 casted on the color regions 110Ar and 110Br with red color in these two adjacent pixels 110A and 110B is substantially equal to the total shadow coverage of the vertical shadow 400 casted on the same color regions 110Ar and 110Br; the total shadow coverage of the oblique shadow 401 casted on the color regions 110Ag and 110Bg with green color in these two adjacent pixels 110A and 110B is substantially equal to the total shadow coverage of the vertical shadow 400 casted on the same color regions 110Ag and 110Bg; and the total shadow coverage of the oblique shadow 401 casted on the color regions 110Ab and 110Bb with blue color in these two adjacent pixels 110A and 110B is substantially equal to the total shadow coverage of the vertical shadow 400 casted on the same color regions 110Ab and 110Bb. As result, the color phase occurring on the display apparatus 40 due to the change of view angle can be compensated when the two adjacent pixels 110A and 110B are viewed as a whole.

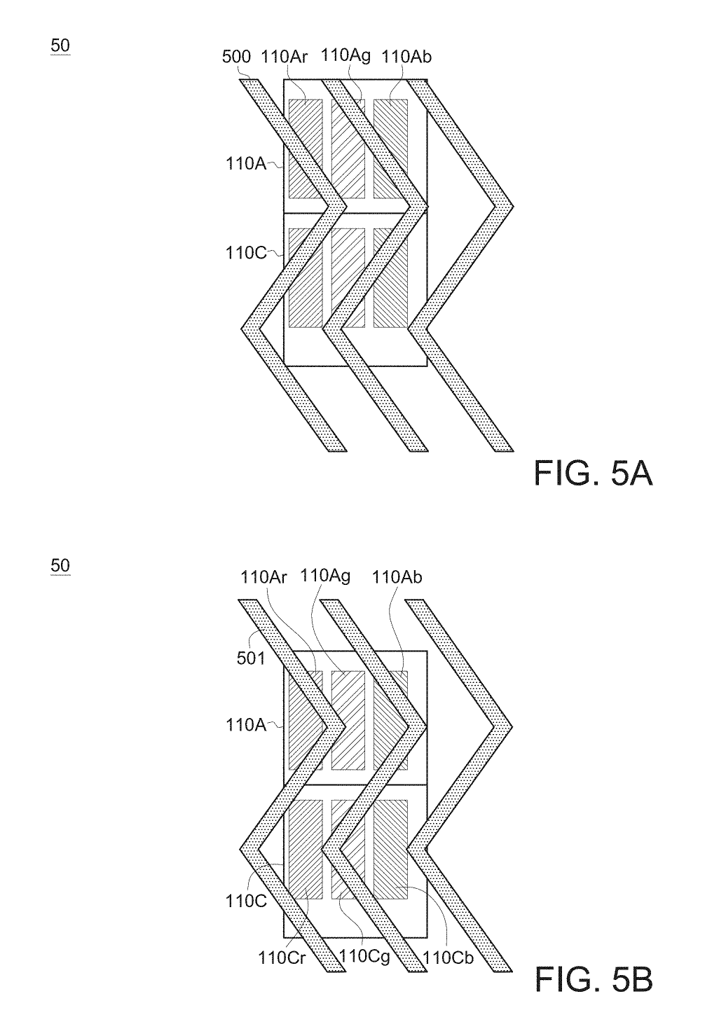

FIGS. 5A and 5B are top views of a display apparatus 50 in accordance with another embodiment of the present invention, respectively illustrating the shadows of the touch detection electrodes 201 (conductive wires 201M) casted on two adjacent pixels 110A and 110B of the display apparatus 50 observed at a vertical viewing angle and at an oblique view point. The structure of the display apparatus 50 is similar to that of the display apparatus 40 except the arrangement of the vertical shadow 500 and the shift direction of the oblique shadow 501. The two adjacent pixels 110A and 110C are arranged along the column direction.

FIG. 5A illustrates the vertical shadow 500 of the touch detection electrodes 201 casted on the pixels 110A and 110C at the vertical view angle; and FIG. 5B illustrates the oblique shadow 501 of the touch detection electrodes 201 casted on the sub-pixels 110A and 110C at the oblique view angle. For the convenience of description, merely two adjacent sub-pixels 110A and 110C arranged along the column direction Y are shown. However, it should be appreciated that there are still other pixels included in the display apparatus 50.

As shown in FIG. 5A, a portion of the vertical shadow 500 casted on the color region 110Ar with red color in the pixel 110A has an area substantially equal to the portion of the vertical shadow 500 casted on the color region 110Cr with red color in the pixel 110C; the portion of the vertical shadow 500 casted on the color region 110Ag with green color in the pixel 110A has an area substantially equal to the portion of the vertical shadow 500 casted on the color region 110Cg with green color in the pixel 110C; and the portion of the vertical shadow 500 casted on the color region 110Ab with blue color in the pixel 110A has an area substantially equal to the portion of the vertical shadow 500 casted on the color region 110Cb with blue green color in the pixel 110C. In other words, the total area of the portion of the vertical shadow 500 casted on the pixel 110A is the same to the total area of the portion of the vertical shadow 500 casted on the pixel 110C.

When the view angle is changed, the shadow coverage may shift upwards, such that the portion of the oblique shadow 501 casted on the color region 110Ar with red color in the pixel 110A has an area substantially larger than the portion of the oblique shadow 501 casted on the color region 110Cr with red color in the pixel 110B; the portion of the oblique shadow 501 casted on the color region 110Ag with green color in the pixel 110A has an area substantially smaller than the portion of the oblique shadow 501 casted on the color region 110Cg with green color in the pixel 110C; and the portion of the oblique shadow 501 casted on the color region 110Ab with blue color in the pixel 110A has an area substantially smaller than the portion of the oblique shadow 501 casted on the color region 110Cb with blue green color in the pixel 110C. The total area of the portion of the oblique shadow 501 casted on the pixel 110A is thus different from the total area of the portion of the oblique shadow 501 shielding on the pixel 110C, and color phase may occur when the view angle is changed.

Although, the shadow coverage (shielding area) of the oblique shadow 501 casted on the color region with a certain color in a particular pixel (either the sub-pixels 110A or 110C) is different. It still can be observed that the total shadow coverage of the oblique shadow 501 casted on the color regions 110Ar and 110Cr with red color in these two adjacent pixels 110A and 110C is substantially equal to the total shadow coverage of the vertical shadow 500 casted on the same color regions 110Ar and 110Cr; the total shadow coverage of the oblique shadow 501 casted on the color regions 110Ag and 110Cg with green color in these two adjacent pixels 110A and 110C is substantially equal to the total shadow coverage of the vertical shadow 500 casted on the same color regions 110Ag and 110Cg; and the total shadow coverage of the oblique shadow 501 casted on the color regions 110Ab and 110Cb with blue color in these two adjacent pixels 110A and 110C is substantially equal to the total shadow coverage of the vertical shadow 500 casted on the same color regions 110Ab and 110Cb. As result, the color phase occurring on the display apparatus 50 due to the change of view angle can be compensated when the two adjacent the pixels 110A and 110C are viewed as a whole.

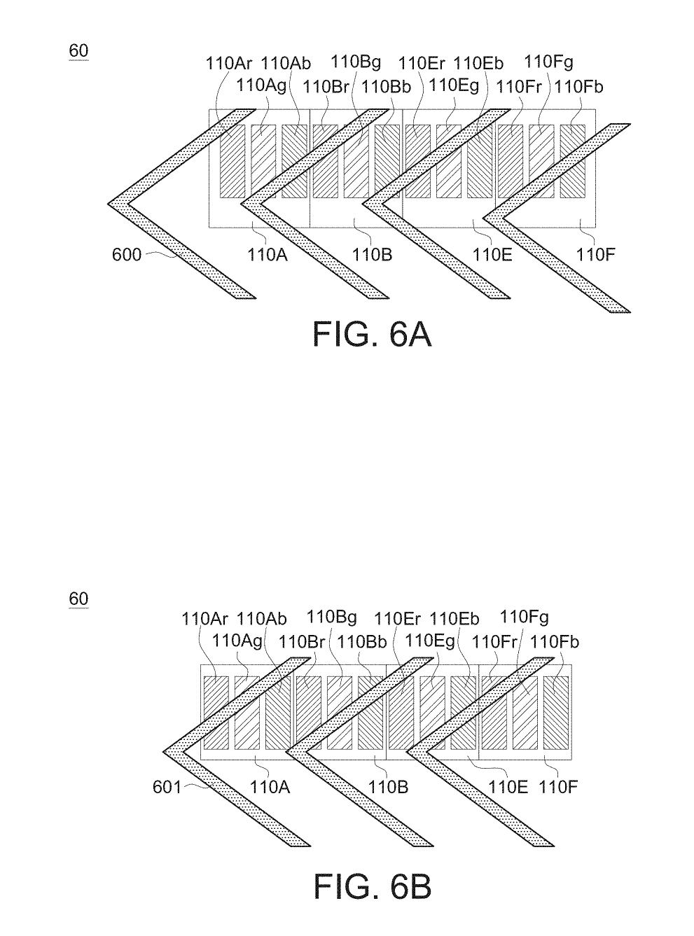

FIGS. 6A and 6B are top views of a display apparatus 60 in accordance with yet another embodiment of the present invention, respectively illustrating the shadows of the touch detection electrodes 201 casted on four adjacent pixels 110A, 110B, 110E and 110F of the display apparatus 60 observed at a vertical viewing angle and at an oblique view point. The structure of the display apparatus 60 is similar to that of the display apparatus 50 except the arrangement of the vertical shadow 600 and the oblique shadow 601. The four adjacent pixels 110A, 110B, 110E, and 110F are arranged along the row direction.

In the present embodiment, the display apparatus 60 applies the set of the touch detection electrodes 201 and the pixels 110 depicted in FIG. 2F which has the ratio of lengths of the first leg Tx and the first side Px of the corresponding pixel 110 (Tx/Px) substantially equal to 4/3; the ratio of lengths of the second leg Ty and the second side Py of the corresponding pixel 110 (Ty/Py) substantially equal to 1; and the ratio of the pitch P to the length of the first leg Tx (P/Tx) substantially equal to 1.

FIG. 6A illustrates the vertical shadow 600 of the touch detection electrodes 201 casted on the pixels 110A, 110B, 110E and 110F at the vertical view angle; and FIG. 6B illustrates the oblique shadow 601 of the touch detection electrodes 201 casted on the pixels 110A, 110B, 110E and 110F at the oblique view angle. For the convenience of description, merely four adjacent pixels 110A, 110B, 110E and 110F arranged along the row direction X are shown. However, it should be appreciated that there are still other pixels included in the display apparatus 60.

A portion of the vertical shadow 600 casted on the color region 110Ar with red color in the pixel 110A has an area substantially equal to the portion of the vertical shadow 600 casted on the color region 110Fr with red color in the pixel 110F; the vertical shadow 600 casted on the color region 110Br with red color in the pixel 110B has an area substantially equal to the portion of the vertical shadow 600 casted on the color region 110Er with red color in the pixel 110E; the portion of the vertical shadow 600 casted on the color region 110Ag with green color in the pixel 110A has an area substantially equal to the portion of the vertical shadow 600 casted on the color region 110Fg with green color in the pixel 110F; the vertical shadow 600 casted on the color region 110Bg with green color in the pixel 110B has an area substantially equal to the portion of the vertical shadow 600 casted on the color region 110Eg with green color in the pixel 110E; the portion of the vertical shadow 600 casted on the color region 110Ab with blue color in the pixel 110A has an area substantially equal to the portion of the vertical shadow 600 casted on the color region 110Fb with blue green color in the pixel 110F; and the portion of the vertical shadow 600 casted on the color region 110Bb with blue color in the pixel 110B has an area substantially equal to the portion of the vertical shadow 600 casted on the color region 110Eb with blue green color in the pixel 110E.

The area of the portions of the vertical shadow 600 casted on the color region 110Ar with red color in the pixel 110A is different from the area of the portion of the vertical shadow 600 casted on the color region 110Br with red color in the adjacent pixel 110B; the area of the portions of the vertical shadow 600 casted on the color region 110Ag with green color in the pixel 110A is different from the area of the portion of the vertical shadow 600 casted on the color region 110Bg with green color in the adjacent pixel 110B; and the area of the portions of the vertical shadow 600 casted on the color region 110Ab with blue color in the pixel 110A is different from the area of the portion of the vertical shadow 600 casted on the color region 110Bb with blue color in the pixel 110B, color phase may likely occur between the two adjacent pixels 110A and 110B and occur between the two adjacent sub-pixels 110E and 110F.

But, because the total shadow coverage of the vertical shadow 601 casted on the color regions 110Ar, 110Br, 110Er, and 110Fr (when the viewing angle is changed) with red color in the four adjacent pixels 110A, 110B, 110E, and 110F is substantially equal to the total shadow coverage of the vertical shadow 600 casted on the same color regions 110Ar, 110Br, 110Er, and 110Fr; the total shadow coverage of the vertical shadow 601 casted on the color regions 110Ag, 110Bg, 110Eg and 110Fg with green color in these four adjacent pixels 110A, 110B, 110E, and 110F is substantially equal to the total shadow coverage of the vertical shadow 600 casted on the same color regions 110Ag, 110Bg, 110Eg and 110Fg; and the total shadow coverage of the vertical shadow 601 casted on the color regions 110Ab, 110Bb, 110Eb and 110Fb with blue color in these four adjacent pixels 110A, 110B, 110E, and 110F is substantially equal to the total shadow coverage of the vertical shadow 600 casted on the same color regions 110Ab, 110Bb, 110Eb and 110Fb. As result, the color phase occurring between the pixels 110A, 110B as well as between the pixels 110E and 110F can be compensated when the four adjacent pixels 110A, 110B, 110E and 110F are viewed as a whole. The color phase shift will not occur when the viewing angle is changed.

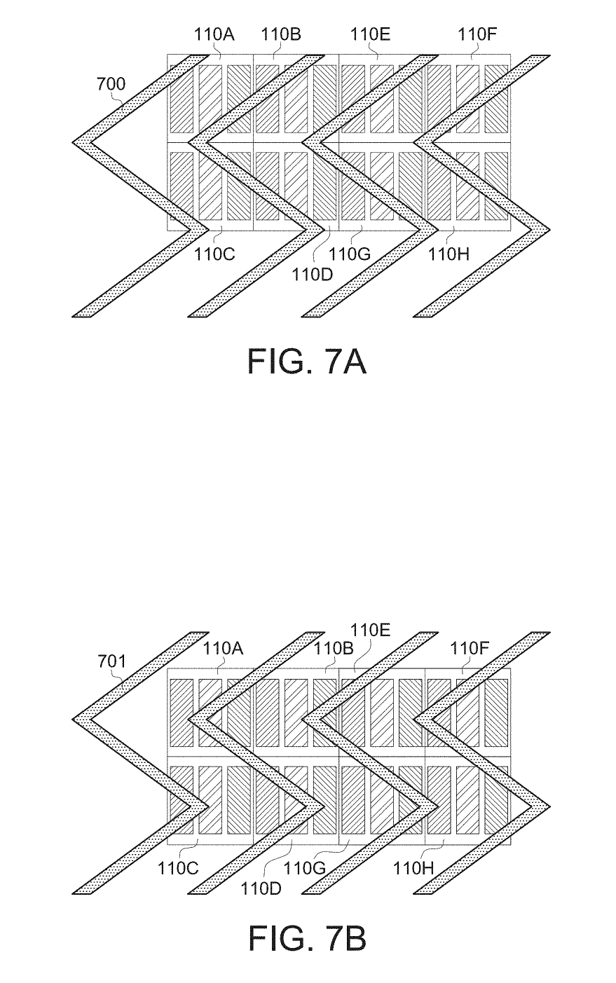

FIGS. 7A and 7B are top views of a display apparatus 70 in accordance with yet another embodiment of the present invention, illustrating the shadows of the touch detection electrodes 201 casted on eight pixels 110A, 110B, 110C, 110D, 110E, 110F, 110G and 110H of the display apparatus 70 observed respectively at a vertical viewing angle and an oblique view point. The structure of the display apparatus 70 is similar to that of the display apparatus 60 except the arrangement of the vertical shadow 700 and the oblique shadow 701. The adjacent eight pixels 110A, 110B, 110C, 110D, 110E, 110F, 110G and 110H are arranged in matrix.

FIG. 7A illustrates the vertical shadow 700 of the touch detection electrodes 201 casted on the pixels 110A, 110B, 110C, 110D, 110E, 110F, 110G and 110H at the vertical view angle; and FIG. 7B illustrates the oblique shadow 701 of the touch detection electrodes 201 casted on the pixels 110A, 110B, 110C, 110D, 110E, 110F, 110G and 110H at the oblique view angle. For the convenience of description, merely eight adjacent pixels 110A, 110B, 110C, 110D, 110E, 110F, 110G and 110H arranged in a matrix are shown. However, it should be appreciated that there are still other pixels included in the display apparatus 70.

Similar to the display apparatus 60, the color phase that may occur between two adjacent pixels can be compensated when the eight adjacent the pixels 110A, 110B, 110C, 110D, 110E, 110F, 110G and 110H are viewed as a whole. And when the viewing angle is changed, the shadow coverage may shift upwards, the color phase that may occur between the two adjacent pixels due to the light shielding of the touch detection electrodes 201 or the change of viewing angle can be also compensated when the eight adjacent the pixels 110A, 110B, 110C, 110D, 110E, 110F, 110G and 110H are viewed as a whole.

In accordance with the embodiments of the present description, a display apparatus with a touch detection function is provided. The display apparatus includes a plurality of pixels and a plurality of conductive wires as the touch sensing electrodes with specific size parameters in respect to the size of the pixels. By applying the conductive wires with specific size parameters, the moiré pattern occurring on the display apparatus can be eliminated or reduced. In addition the specific size parameters can also compensate the color phase occurring between adjacent pixels due to the light shielding of the conductive wires and the change of view angle. The resistance of the touch sensing electrodes and the thickness of the display apparatus can be reduced without affecting the resolution and display quality of the display apparatus.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus with touch detection function, comprising:
a display medium comprising a plurality of pixels each constituted by a plurality of color regions with different colors arranged in a matrix with a plurality of and rows and columns, wherein the pixel has a first side (Px) along a row direction and a second side (Py) along a column direction; and
a plurality of touch sensing electrodes each comprising a plurality of conductive wires, the conductive wire overlapping with the pixels and comprising at least one first portion extending in a first direction at a first angle with respect to the column direction, and at least one second portion connecting with the first portion and extending in a second direction at a second angle with respect to the column direction;
wherein the first portion crosses at least one pixel serving as a hypotenuse of a right triangle with a first leg (Tx) parallel to the row direction and a second leg (Ty) parallel to the column direction; a ratio of lengths of the first leg (Tx) and the first side (Px) substantially ranges from 1/3 to 7/3; and a ratio of lengths of the second leg (Ty) and the second side (Py) substantially is larger than 0.8 and less than 2.

2. The display apparatus according to claim 1, wherein the second portion has a size and a shape identical to that of the first portion.

3. The display apparatus according to claim 1, wherein the conductive wire is formed as a zigzag line or a wavy line.

4. The display apparatus according to claim 3, wherein the conductive wire includes a plurality of the first portions and a plurality of the second portions, wherein the first portions and the second portions are continuously connected along the column direction.

5. The display apparatus according to claim 4, wherein the touch sensing electrode include two adjacent conductive wires disposed along the row direction and separated from each other with a pitch, wherein a ratio of the pitch to the length of the first leg (Tx) is equal to or less than 1.

6. The display apparatus according to claim 1,
wherein the pixels includes a plurality of first color regions of a first color,
wherein when the display apparatus is viewed by an user from a first viewing angle, the conductive wires in a predetermined set of adjacent pixels has a vertical shadow casted on the pixels to define a first shielding area on at least two of the first color regions,
wherein when display apparatus is viewed by the user from a second viewing angle different from the first viewing angle, the conductive wires in the predetermined set of adjacent pixels has a vertical shadow casted on the pixels to define a second shielding area on the at least two of the first color regions,
wherein the first shielding area is substantially equal to the second shielding area.

7. The display apparatus according to claim 6, wherein the predetermined set of pixels includes at least two adjacent pixels arranged along the row direction.

8. The display apparatus according to claim 6, wherein the predetermined set of pixels includes at least two adjacent pixels arranged along the column direction.

9. The display apparatus according to claim 1, wherein the touch sensing electrodes has a vertical shadow casted on two adjacent pixels with different areas.

10. The display apparatus according to claim 1, wherein the touch sensing electrodes has a vertical shadow casted on two adjacent pixels with the same areas.

11. The display apparatus according to claim 1, wherein the first angle is substantially equal to the second angle.

12. The display apparatus according to claim 1, further comprising a substrate, wherein the metal wires are disposed on the substrate.

13. The display apparatus according to claim 12, further comprising a color filter layer disposed on the substrate.

14. The display apparatus according to claim 1, wherein the ratio of lengths of the first leg (Tx) and the first side (Px) substantially ranges from 2/3 to 2.
